(19) United States
(12) Patent Application Publication
(10) Pub. No.: US 2004/0175159 A1
(43) Pub. Date: Sep. 9, 2004

(54) Searchable DVD incorporating metadata

(76) Inventors: Kenneth G. Oetzel, Novato, CA (US); Christopher Anthony Kryzan, San Rafael, CA (US)

Correspondence Address: PARSONS HSUE & DE RUNTZ LLP, SUITE 1800, 655 MONTGOMERY STREET, SAN FRANCISCO, CA, 94111, US

(21) Appl. No.: 10/754,136

(22) Filed: Jan. 8, 2004

Related U.S. Application Data
(60) Provisional application No. 60/439,055, filed on Jan. 8, 2003.

(51) Int. Cl. H04N 5/781

(52) U.S. Cl. 386/125; 386/126

(57) ABSTRACT

The present invention relates to improvements in the storage and searchability of DVDs' content and metadata. It presents an authoring process to simulate interactivity on limited-function playback devices, such as conventional DVD players. This is achieved by simulating content access functions, such as sorting, scrolling, paging, grouping, describing content, etc., on a device where these functions are lacking. Further, it has the ability to create simulated functions in multiple languages or multiple representations that can be selected by the user or determined automatically by the implementing software. This is achieved by pre-processing and pre-creating the menus and other elements to make it look like a DVD player is sorting, grouping, etc., although all it is really doing is jumping from menu to menu.

### CROSS-REFERENCE TO RELATED APPLICATION

This non-provisional application is related to and claims priority based on U.S. Provisional Application No. 60/439,055, entitled “Searchable DVD Incorporating Metadata,” filed on Jan. 8, 2003, which is incorporated herein in its entirety by this reference.

### BACKGROUND OF THE INVENTION

1. Field of the Invention

This invention relates generally to the development of interactive media, such as a DVD, and, more specifically, to allowing a DVD to be searchable based upon metadata contained therein.

2. Background Information

DVDs and similar media can contains large amounts of presentation data relative to many other portable storage media, on the order of dozens of video titles and hundreds of music titles. It is also possible to store large amounts of data about this content, or metadata, on a DVD along with the content itself. This can be metadata made up by the users themselves or supplied by an outside source, including things like titles, synopses of recorded shows, genre of songs, album details, and so on. Although all of this metadata may be on the DVD, it is not readily searchable by the user when the disc is played. Standard DVD players lack this capability and typically restrict the users searching of the contents to title alone, with other search abilities, menus and metadata content display being limited or non-existent. Further, it cannot be readily added to DVD players as they both conform to specified protocols and lack the processing capability. Even when a DVD is played upon a computer, the computer would search the metadata content of a DVD by typically downloading the metadata from a separate database and then search it, requiring both computing power and time.

Consequently, with the increased presentation data storage capacity of DVDs along with the increased availability of metadata about this content, it would be of utility to users to be able to have metadata search and other increased capabilities available within a DVD player.

### SUMMARY OF THE INVENTION

The present invention relates to improvements in the storage and searchability of DVDs' content and metadata. It presents an authoring process to simulate interactivity on limited-function playback devices, such as conventional DVD players. This is achieved by simulating content access functions, such as sorting, scrolling, paging, grouping, describing content, etc., on a device where these functions are lacking. Further, it has the ability to create simulated functions in multiple languages or multiple representations that can be selected by the user or determined automatically by the implementing software. This is achieved by pre-processing and pre-creating the menus and other elements to make it look like a DVD player is sorting, grouping, etc., although all that it is really doing is jumping from menu to menu.

In a first aspect of the present invention, the process can automatically include sorting by various categories in a database-driven method. In another aspect, the produced menus can include menus that are self-descriptive to the end-user, in that they contain context-sensitive information that describes what type of format they are recorded in and what can be done with them (i.e., it can be re-recorded, etc.) by sensing the particular type of DVD media and providing this information (and what it means) to the user. A further aspect allows for the automatic determination of what buttons are needed for a specific menu and it places them there (e.g., Sort by title, Sort by date, etc.). Another aspect automatically includes scrolling across pages. Yet another additional aspect provides for automatically producing a multi-lingual version with localization, which can be changed in a “Settings” menu. A further aspect includes an expansion to styles to include multi-menu styles and dynamic text inclusion (related text files provide context-sensitive text for use in the style). An additional aspect involves the inclusion of a “bit budget” on the DVD, which is a graphic and text indicator within display screens of the disc to indicate to the user the amount of space used and remaining for use on the disc. All pictures with a bit budget indicator are updated each time information is added to, or deleted from the disc, so that a disc is self-referential with regards to how much available space it has on it.

Consequently, the present invention readily allows a home user to record content, such as television shows and other video or audio content to DVD. The associated software allows it to be readily incorporated into existing computer systems to exploit their screen menus and remote control abilities, enabling users to browse and select their favorite recorded television programs, treasured videos, and memorable slideshows and burn them onto DVDs. In a preferred embodiment, it can be launched using a compatible remote control by simply clicking a button on a start menu. Incorporating a conventional interface design, on-screen menus make it easy to recorded TV programs, including program information from an electronic program guide, as well as browse through videos and slideshows.

Recorded discs can be played on PC-based and set-top DVD players worldwide. The method incorporates technology that DVDs so created can be opened, edited and re-burned using compliant applications. With the ability to update and further customize their DVDs, users can continually add to their collections of recorded programs, for example, putting new episodes on their DVDs each week. The method also includes a built-in bit budget, which makes it easy to see how much space is available on each recorded DVD. Once the user starts burning a DVD, they can return to watching TV or listening to music on their PC.

Additional aspects, features and advantages of the present invention are included in the following description of exemplary embodiments, which description should be read in conjunction with the accompanying drawings.

### BRIEF DESCRIPTION OF THE DRAWING

FIGS. 1-10 and 24-28 show presentation data related to a first embodiment.

FIGS. 11-19 show presentation data related to a second embodiment.

FIGS. 20-23 show presentation data related to a third embodiment.

FIG. 29 is a block diagram illustrating various aspects of the present invention.

FIG. 30 is a flow chart of the process for forming the media content in the exemplary embodiment.

FIG. 31 is a schematic diagram of a system for playing media formed according to the present invention.

FIG. 32 is a schematic illustration of how the sort views of the search data can be formed.

FIG. 33 shows an information appliance in which the various aspects of the present invention can be executed.

### DESCRIPTION OF REPRESENTATIVE EMBODIMENTS

Within the DVD Forum's DVD specification (which is hereby incorporated by reference), the contents are only searchable by title. If additional data, such as metadata or other content identifiers, are added, the present invention allows for the generation of menus allowing the user to search by the metadata, even though the DVD specification does not allow this. This is accomplished by pre-rendering a database to be searchable without a processor, as a DVD player lacks this capability. The present invention provides a software-implemented technique to presort and render presorted discs. The resultant DVD consequently looks to the user as if has the desired search ability as the pre-rendering produces menus which are searchable within the DVD standard. In a simplified description, it allows the DVD to simulate the abilities the user may want while using the reduced abilities that the DVD player actually possesses. The method can also provide the appropriate buttons, for example based upon the text of the metadata, and automatically generate multi-lingual content for the menus.

One element that can be included in the rendered menus is a bit budget that can indication how much space is available on disc. Even though a DVD player may not be able to write to the disc, the bit budget can allow a user to determine if a particular disc has room for further content. Thus the user can decide which disc is suitable to add some form of content—the DVD can just be put in player to hunt and see whether it has free space. When the DVD actually has additional material recorded onto the disc, the software will re-render menus, including the bit budget. Other screens and menus will present the user with information on the particular media type and explain it.

The various menus can also include autoscrolling to simulate up and down arrows for scrolling. As actual scrolling is not compatible with the DVD standard, each “scrolling” action would jump to a different, pre-rendered screen with the selection based on hot spots, for example, along the scroll bar. (Menus and other aspects of the DVD media are described more fully in DVD Demystified, Second Edition, by Jim Taylor, McGraw-Hill, 2001, which is hereby incorporated by reference.)

The present invention also incorporates dynamic text inclusion. For example, when recording television, metadata can be provided by a program guide and include the sort of information shown in the figures. With music, metadata can be provides through the “All Music Guide” (AMG); another source of metadata is through the DirectShow (formerly ActiveMovie) application. If, say, photographs in JPEG or other form where being stored, the metadata could include things such as date, F-stop values and other settings, and so on. The metadata can also include information specifically entered by the user, where, again, various examples are shown in the figures. In any of these cases, the process can allow searching on the various metadata. The current DVD specification has a single template of a set number of buttons, if searchable. The present invention allows this to be extended to many prototypes. Depending on how the metadata and content is sorted, this information will be used to determine the needed prototypes and dynamically generate the menus.

The following discussion begins with examples where the content is music, followed by a video embodiment. In all these cases, the procedures are similar, although some features make more sense in one context than another; for example, random play of music selections within a genre is more likely to be of interest than the same feature for recorded television shows. In all of the examples, the process is based on a DVD player of relatively limited possibilities acting as a surrogate for one with greater capabilities. As the DVD has a large available content, the data can be preprocessed before writing the material to disc and hundreds or thousands of screens can be stored along with the actual music, video, etc. content. When the disc is generated, it can be sorted by metadata tags, a library can be compiled, and the software will then assemble the various menus and place them on the disc (along with the content) in a way compatible with the player.

The first pair of embodiments is based on a format that combines DVD and recorded audio, such as a compilation for personal use of downloaded and ripped audio. Due to the capacity of a DVD, this can contain hundreds of tracks, be changed over time, and contain more than just audio data. Embodiments are described where the disc can be played on DVD players connected to TVs, on PC-based players, in personal mobile players and in-dash players. It is designed to work on devices connected to a large, color graphics display, and on those with monochrome LCD panels.

When specific details are required, much of the present discussion is presented in an example based on the “OpenDVD” format. This format transforms DVD media into changeable, editable content, something which is a necessity for the large and dynamic music libraries that typify today's environment. Applications and formats built around this specification, combined with read/write media, deliver important capabilities not found in the DVD specification. This is described further in the U.S. patent application entitled “End-User-Navigable Set of Zoomed-In Images Derived from a High-Resolution Master Image”, Ser. No. 10/119,993 filed Apr. 9, 2002, the U.S. patent application entitled “Interactive Media Authoring without Access to Original Source Material”, Ser. No. 10/123,816 filed Apr. 15, 2002, and U.S. patent application entitled “Optimizing The Recording on a Rewritable Interactive Medium of Revisions To An Existing Project on that Medium”, Ser. No. 10/408,027 filed Apr. 3, 2003, all of which are hereby incorporated by reference.

It is well known in the art that logic or digital systems and/or methods can include a wide variety of different components and different functions in a modular fashion. The following will be apparent to those of skill in the art from the teachings provided herein. Different embodiments of the present invention can include different combinations of elements and/or functions. Different embodiments of the present invention can include actions or steps performed in a different order than described in any specific example herein. Different embodiments of the present invention can include groupings of parts or components into larger parts or components different than described in any specific example herein. For purposes of clarity, the invention is described in terms of systems that include many different innovative components and innovative combinations of innovative components and known components. No inference should be taken to limit the invention to combinations containing all of the innovative components listed in any illustrative embodiment in this specification. The functional aspects of the invention, as will be understood from the teachings herein, may be implemented or accomplished using any appropriate implementation environment or programming language, such as C++, Java, JavaScript, etc.

For specificity, in the music based first pair of embodiments, the DVD will be taken as having a content of near 1,000 songs, the ability for (simulated) expansion to 5.0 surround sound, and be based on the OpenDVD standard. As noted, this standard allows for the inclusion of both additional, descriptive metadata and to also be changed over time. Additional tracks can be added, songs removed, playlists changed, turning it into a dynamic medium that can respond to the listener's changing preferences. The on-board metadata can include textual information provided with downloads, thanks to application linkages to the All Music Guide (AMG) music database. This information will be stored within the OpenDVD section, or “egg”, of the disc. Full, graphical navigation, in a consistent and standard format, for playback on set-top or PC-based players connected to a TV or video display is included to make it easy to quickly find and play desired material. The disc is also taken as playable on set-top and PC-based players (the first embodiment) and on in-dash and other mobile players (the second embodiment).

Tables of contents can be automatically generated for a variety of search vectors, effectively providing an on-board database, making searching for songs to play simple and easy. The disc can also be easily navigated on mobile players, whether handheld or automotive. It can also include integrated pictures (Slideshows), such as jacket picture, artist promotional pictures, etc., (from, say, AMG) that play along with the music and integrated links to interactive, Web-based content. This last also provides opportunities for embedded e-commerce.

The present invention allows the creation of a playback experience that is easy to navigate, for set-top, PC and mobile playback. It also allows the playability be as ubiquitous and compatible as possible. For this reason, the exemplary form of the base format will be DVD-Video, and extensions to that format will be encompassed within the “egg”, and that a special form of an OpenDVD disc be defined for music applications. That means that music will play on any DVD-Video compatible player.

The exemplary music disc holds up to 1,000 songs, which are organized into albums and playlists (which are structurally the same, playlists are defined by the user, and albums are simply playlists defined by a studio). The maximum number of songs can vary, of course, and is limited by the space on the disc, less overhead and space allocated to other content, such as graphics. A 4.7 GB disc with only audio on it would have room for about 3,264 minutes of stereo audio encoded with Dolby Digital™, as described below.

The disc also contains extensive metadata, which is used to embed the descriptive information about each album, artist, playlist and title. It can also contain navigational data that is an instantiation of the music database that relates titles, albums, artists, playlists and genres to each other. This information can be contained, for example, within the OpenDVD egg, in a proprietary format which is a special type of OpenDVD title. Some of this information (album art and title, for example) is also contained within the DVD-Video data structures, such as jacket picture and text data, for real-time display during playback. Playing such a music disc on a standard DVD-Video player results in an experience that is better than a random music disc for the many reasons identified above.

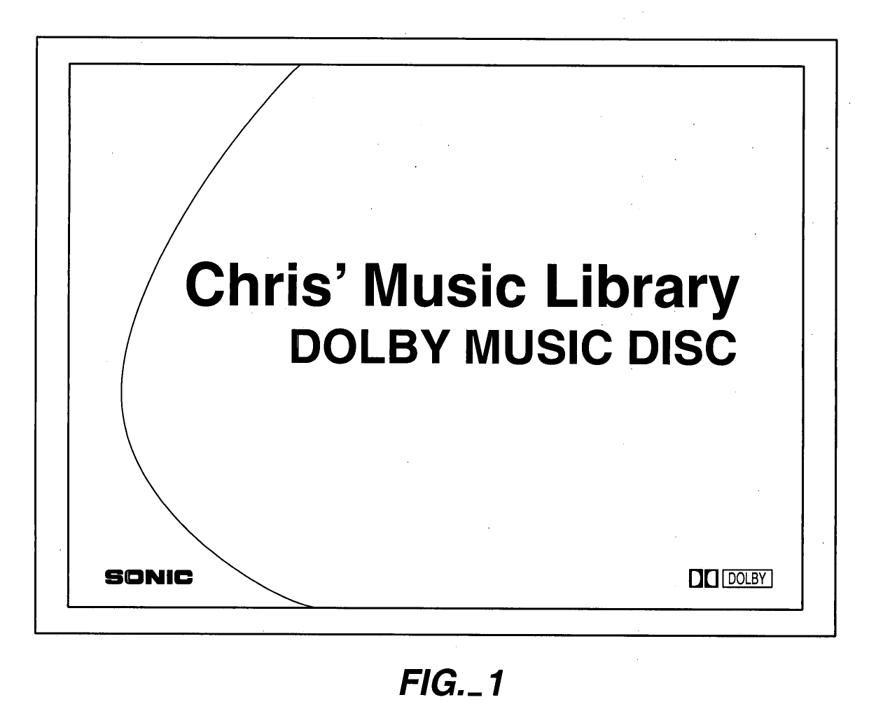

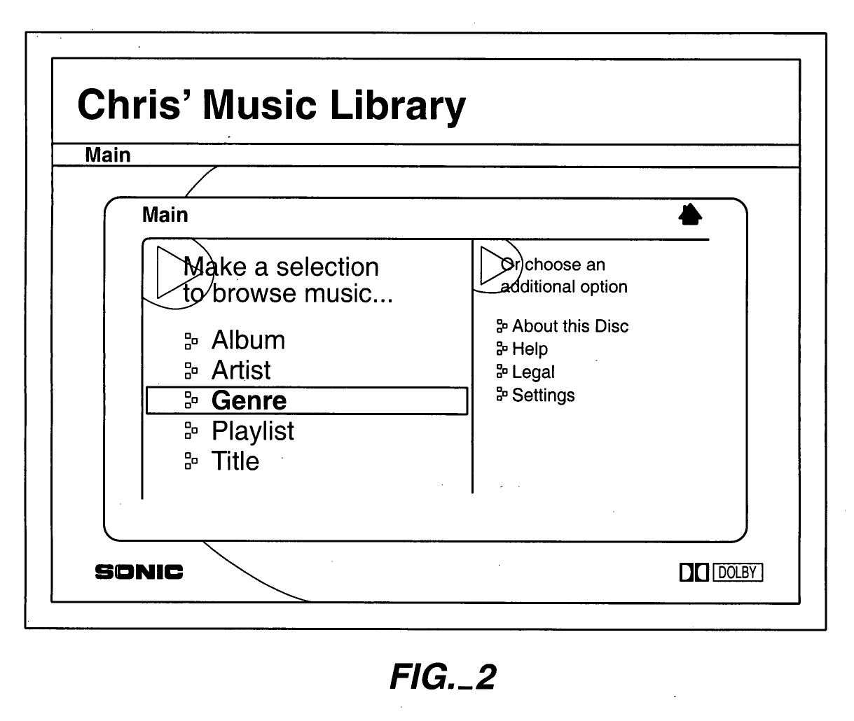

The first embodiment is the playback of an audio content disc within a TV/PC environment and begins with inserting the media in the player. A splash screen (FIG. 1) comes up and identifies the title. It goes away after approximately five to ten seconds, and is replaced by the main navigation window. The main navigation window (FIG. 2), allows the user to search the music disc by album, artist, genre, playlist or title. A selection is made using the arrows on the remote control and scrolling through the list, and then clicking Enter on the choice. The listener can also choose About, Help, Legal and Settings.

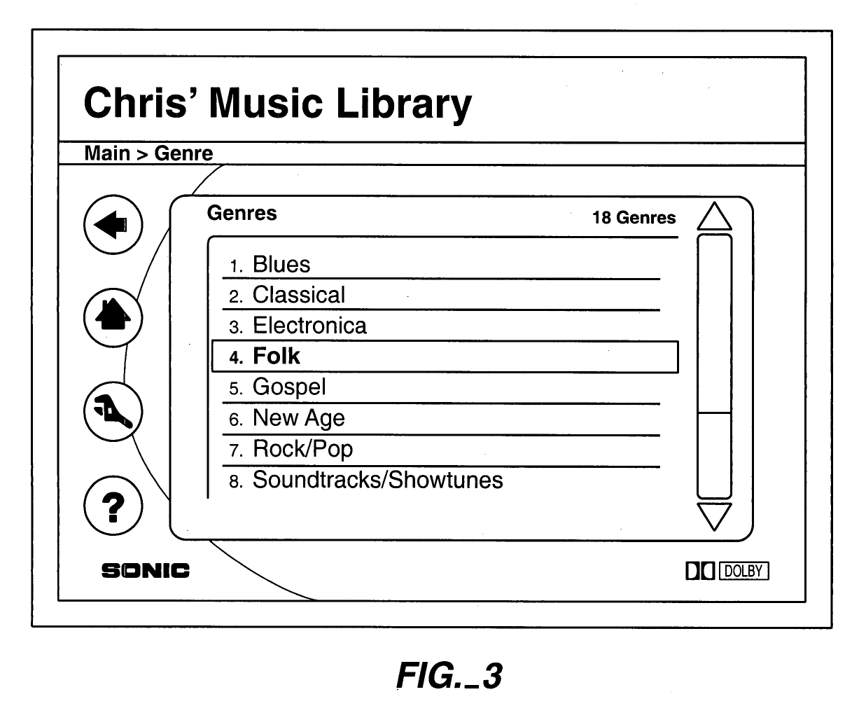

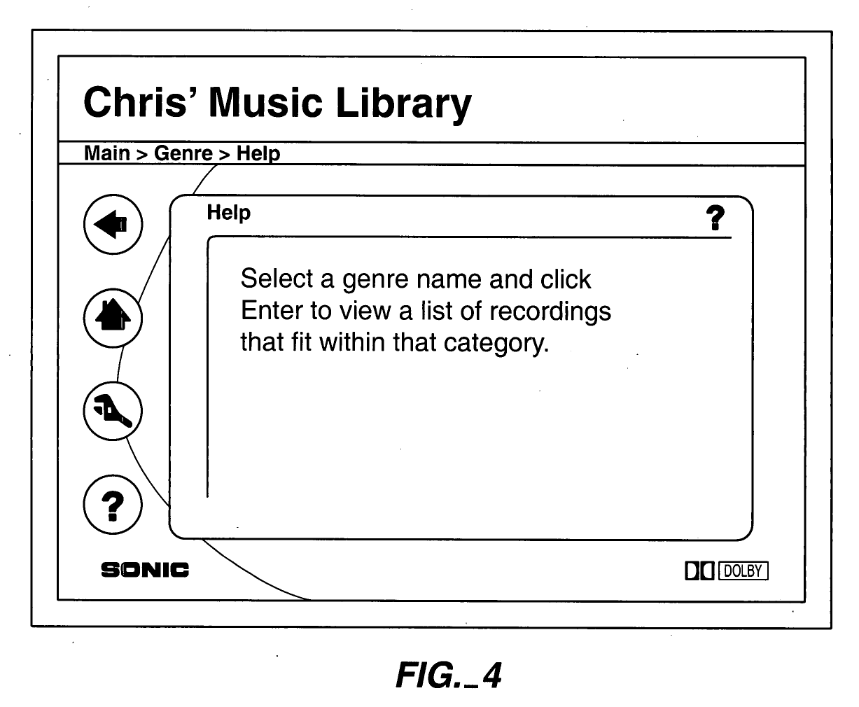

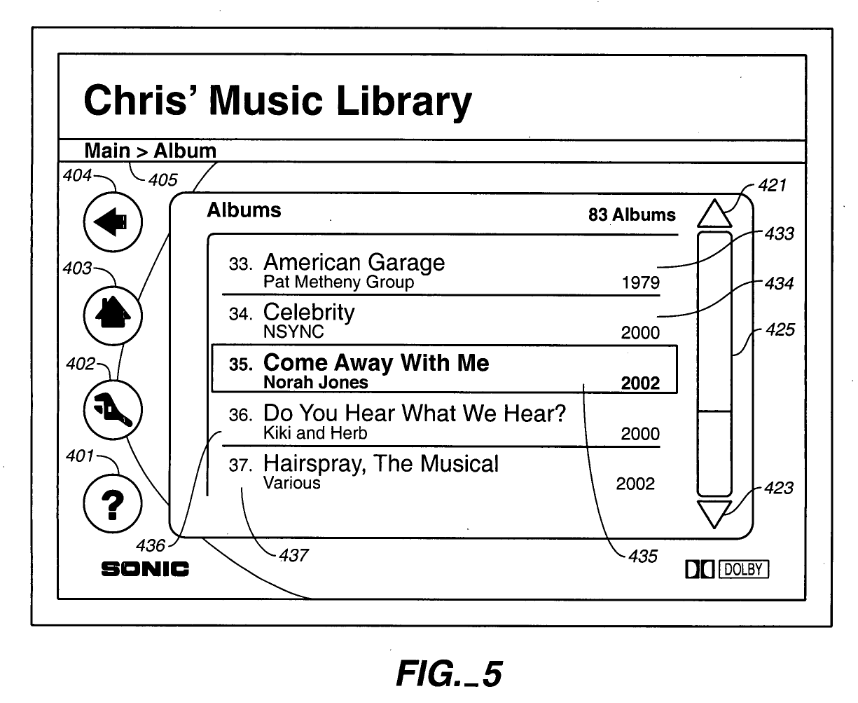

In this example, the listener will decide to search by genre, which they select (shown by the highlighting in FIG. 2) and then click. The Genres search screen or sort view (FIG. 3) is displayed, allowing the user to pick one that meets their mood. The user can scroll through the list by scrolling the selected line, using the remote arrows, down past the bottom item, or by clicking on the yellow up/down arrows, or by clicking to a relative position in the scrollbar on the right. An integrated help facility (FIG. 4) can be built into the disc. If the user is uncertain what to do next, they can click on the question mark button on any screen and a context-sensitive help screen will be displayed. They make their selection, and a list of albums (FIG. 5) within this category appears. The album list contains additional information, including artist and year of release. The listener clicks on the album they want to listen to, and then the Album Details screen appears.

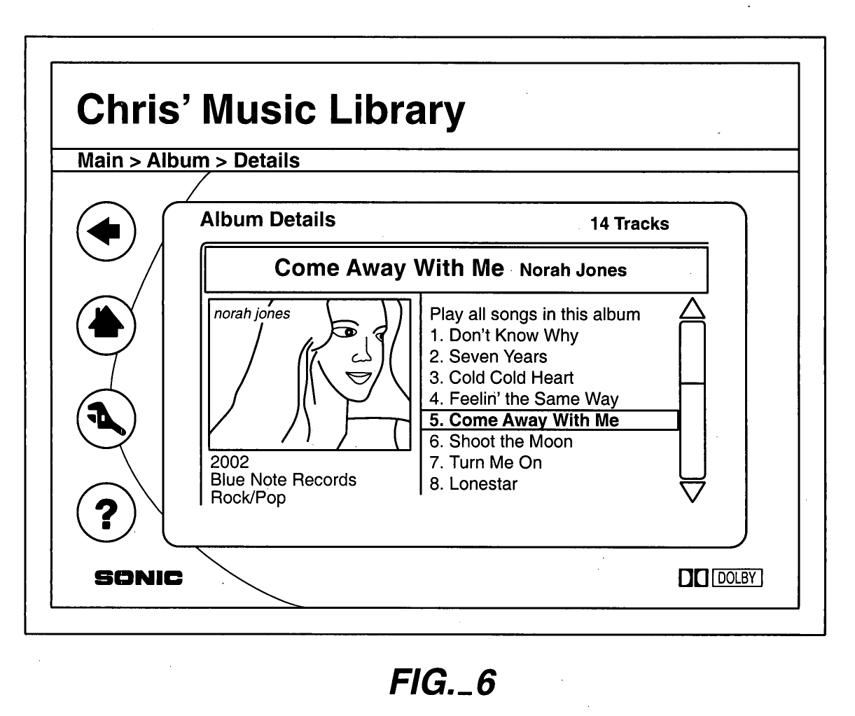

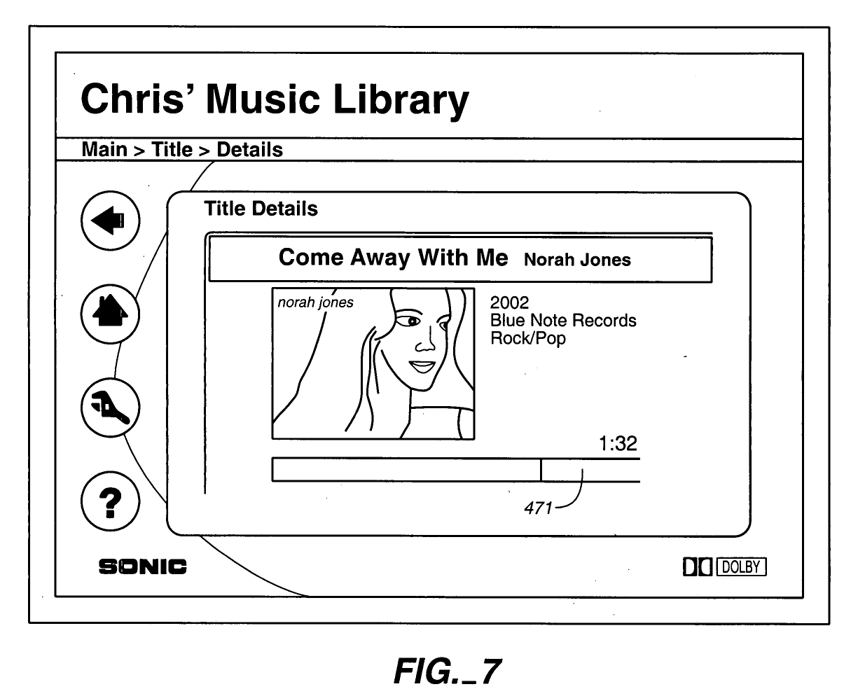

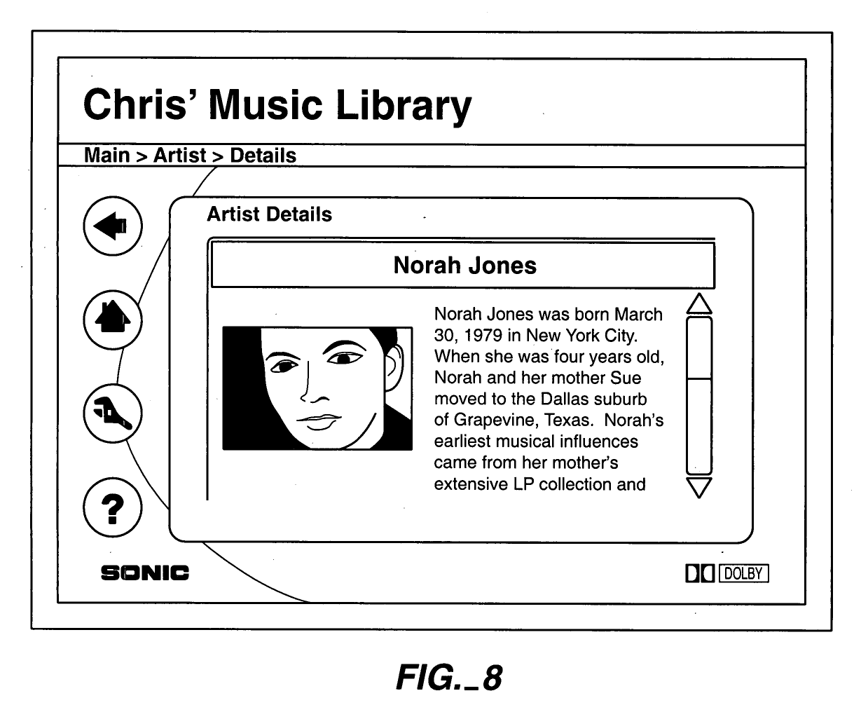

The Album Details screen (FIG. 6) includes the track list for the album, album art, and other interesting information. The listener can play all songs in the album that is the first selection item in all cases or scroll through the track list and play an individual track. While the track is playing, whether it was selected individually or as part of the entire album or playlist, a Title Details screen (FIG. 7) is displayed, with information on that particular song. A progress bar 471 can be added. This screen is updated as each new track is played. The listener might want to find out more about the artist, so clicks on the artist's image in the Album screen, and they are presented with a biography (FIG. 8).

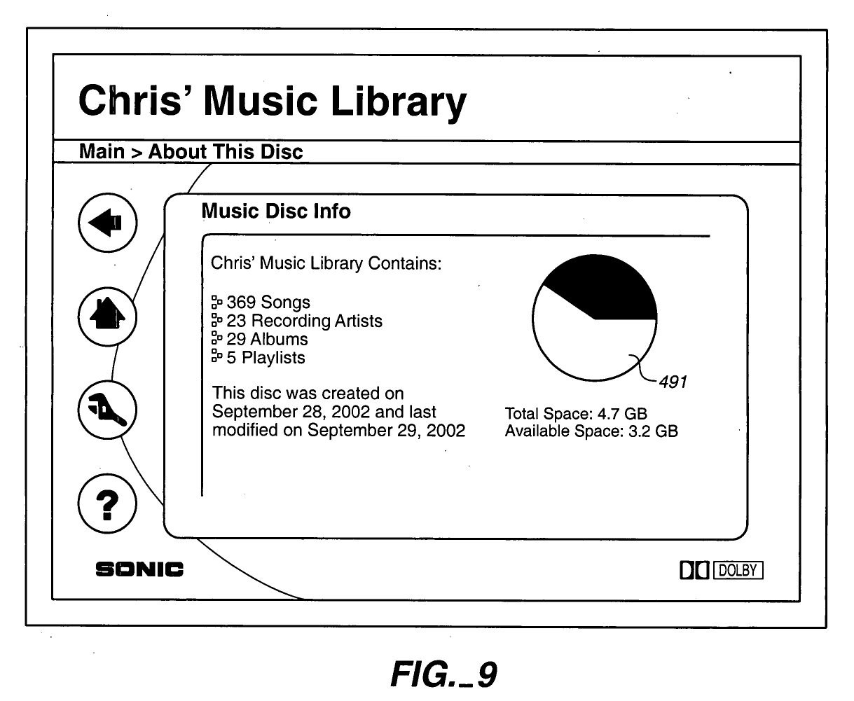

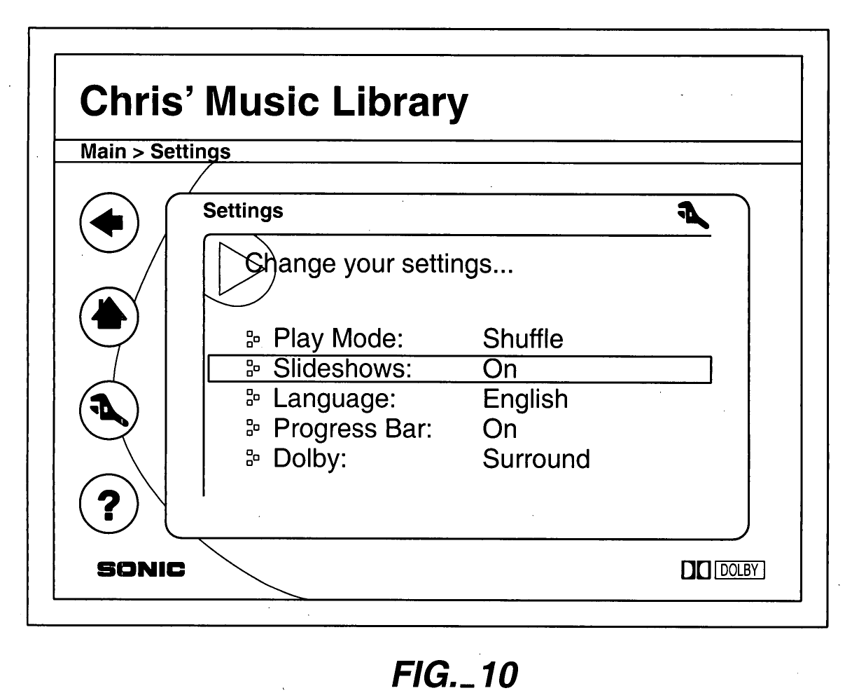

As tracks are added to the disc, the available space is used up, and it is helpful to get a snapshot of how much room is available to store new downloads. The Disc Info screen (FIG. 9) provides an easy means of finding that out. A disc may be configured for playback in much the same manner as an MP3 player, with special features such as random, repeat and shuffle play. The Settings screen (FIG. 10), reachable from any other screen, makes it convenient and quick to change the playback mode.

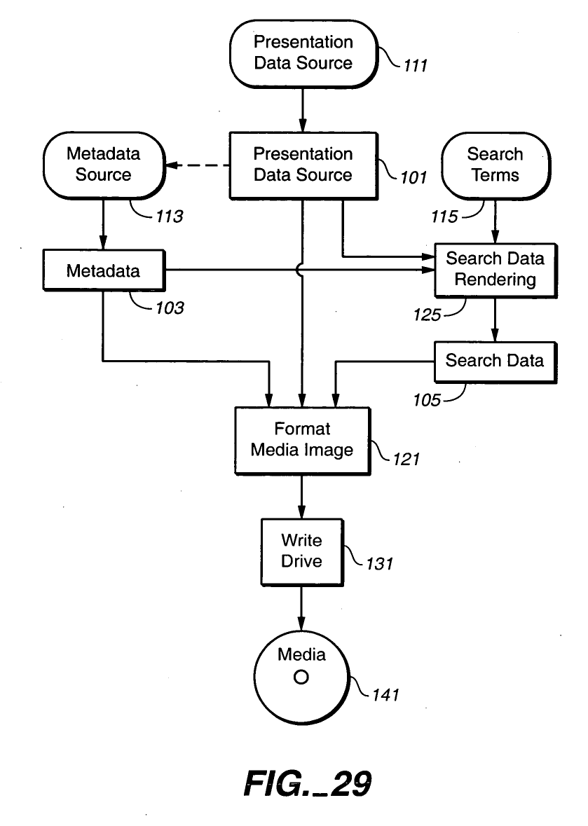

FIG. 29 is a block diagram illustrating various aspects of the present invention, which is again based on a DVD based embodiment. More generally, the various methods and techniques of the present invention can be applied to any interactive media, by which is meant a medium storing both presentation data and various menus, tables of content, or other display by which the user can select from the presentation data. Some of the optical disc based exemplary embodiments for DVD and CD based formats and protocols include DVD-Video, DVD-Audio, Video CD, and Super Video CD, and DVD-R, DVD-RW, DVD+R, DVD+RW, DVD-RAM, CD-R, CD-RW, and other such formats.

The presentation data 101 is supplied from source 111. For example, this could be video from a cable station, music from a CD, photos from a digital camera, and so on. The metadata 103 is supplied from source 113, such as the Directshow or All Music Guide (AMG) music databases or from the user themselves. The supplying of the metadata 103 from the source 113 can be automatic based on the presentation data 101 themselves, as indicated schematically by the broken line. This process would be implemented by the software that would identify the presentation data 101 to the metadata source 113, which would respond with the associated metadata 103. In other cases, the user would identify the presentation data to the metadata source or supply the metadata themselves. For example, if the presentation data is a series of photos, the user could enter date, F-stop values and other settings, or annotate the automatically supplied metadata with their own input.

Once the metadata 103 and presentation data 101 are obtained, the software will render the corresponding search or sort data in the process 125. The search categories can be a set of automatic default categories (such as genre or others described in the examples), or the user may select from a set of categories or supply their own. Based on these, the search data 105 is rendered. The presentation data 101, the metadata 103, and the search data 105 form the content that will actually go onto the disc as the part of the media image. The rending process 125 can also generate any self-referential data for the medium, such as a bit budget or information on the particular media type. To generate the self-referential data, the process 125 may also require input from the medium itself, such as how much data is already on the disc or media type.

When the process is being performed starting with content already on the medium, for example when adding TVs to those already on a DVD, the search data will be re-rendered to incorporate both the new metadata and the already present metadata. In such an update, all of the data (presentation, meta-, and search data) can be rewritten to the media or, preferably, only the new material will be written as in the process described in U.S. patent application Ser. No. 10/408,027, which was incorporated by reference above. The existing presentation data and metadata could be left on the medium and only the new presentation data and metadata, along with the new search data incorporating both the new and existing content. For example, in the DVD case the new elements in the search data would be inserted into the tables of contents for the search data, which would then be subjected to a repagination as needed.

In either case, once the presentation data 101, metadata 103, and search data 105 are assembled, they can be formatted into the media image in the process 121. In the DVD case, the search data is formed into tables of contents (TOCs) such as that described below with respect to FIG. 5. Once the media image is formed, it is written by a write drive 131 onto the medium 141. In the case of updating content already on the medium, the write is to same medium. In this case, the drive 131 can also access the existing content on the disc in order to form the updated search data.

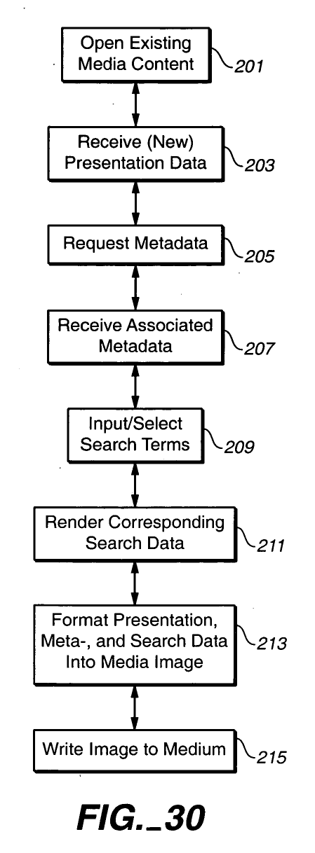

FIG. 30 is a flow chart of the process for forming the media content in the exemplary embodiment, where the order of those steps that are not dependent upon preceding steps can be performed in different orders. If the media already has content written on it, say several episodes of a TV show to which the user wishes to add, the existing content is opened in step 201. In step 203 the presentation data (or additional presentation data) is received. When starting from scratch with a blank medium, the process would begin in step 203. In an automatic process, the associated metadata is requested from the source in step 205. Whether automatically supplied or input by the user, the associated metadata is received in step 207.

Once in possession of the presentation data and metadata, the search data is rendered from these in step 211. The various search menus can either be predefined and automatically implemented, or presented to the user to select from; alternately, this could be supplied or augmented by the user. This would include the information for the newly supplied information from steps 203 and 207, as well as any existing data that was already on the medium. If any self-referential data is being generated, such as the bit budget, it would also be generated in step 211. (Any disc-related data needed to generate self-referential data, such as the bit budget, could also be read off the medium in step 201.)

The media image, including the presentation, meta-, and search data, as well as any self-referential data is formed in step 213. The various details of the process for forming a media image are describe in more detail U.S. patent application Ser. Nos. 10/119,993, 10/123,816, and 10/408,027 incorporated by reference above. The process ends with writing the media image at step 215. Subsequently, when new presentation data is added, the process will begin again at step 201.

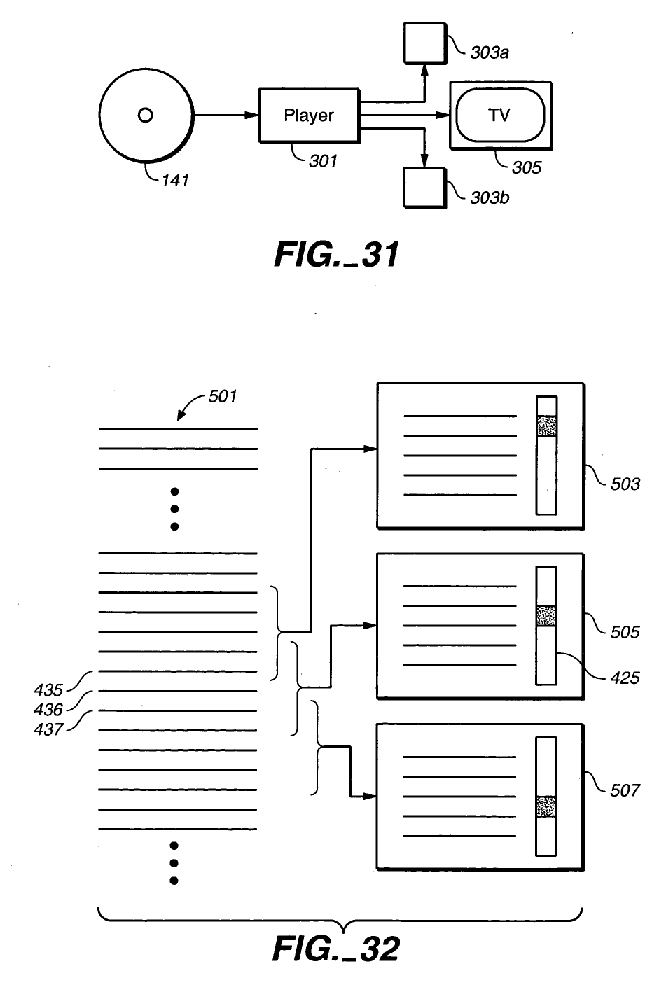

In the music disc on a standard DVD-Video player example discussed above with respect to FIGS. 1-10, the presentation data is music while the metadata and search data are presented as screens such as those show in the figures. From reference, a box diagram of the system for playing such a DVD is shown in FIG. 31. The disc 141 is placed into the standard player 301, with the music presentation data going to the (in this example) two speakers 303a and 303b and the monitor or TV set 305 displaying the screens. FIG. 2 shows examples of categories by which the metadata was searched, with FIG. 5 as one example of search data for the category “albums”. Although this gives the appearance of the dumb set-top player being able to search the database based upon album title, FIG. 5 is actually a pre-rendered menu or table of contents.

Within FIG. 5, there are a number of buttons allowing the user to select presentation data or other screen. Some of buttons appear explicitly as buttons, such as the button 401 to the help screen (FIG. 4), the button 402 to the setting screen (FIG. 10), the button 403 to the main screen (FIG. 2), and the button 404 to the next screen up, here the main screen as shown at 405. The actual number of albums in the example is shown as 83, of which five are displayed on the screen. Each of the album listings (433, 434, 435, 436, 437) are also buttons that allow that particular presentation data to be selected as well as display the associated metadata. Here, selected the highlighted choice of 435 leads to the metadata shown in FIG. 6. To move up and down the list of search data, the buttons 421 and 423 are provided.

Taking into account all of the buttons described so in FIG. 5, this uses a dozen of the number of buttons allocated for each screen in the DVD specification. The rest of the twenty-odd allocated buttons can by used in the scroll bar. Although appearing as a single item, the scroll bar 425 is actually a linear arrangement of these remaining buttons, where the exact number chosen for a given set of search data would be appropriate for the granularity of the number of selections displayed (here 5) relative to the entire set (here the 83 albums). Conceptually, the entire set of a given search data can be conceptually be considered a list 501 of the entire set as shown in FIG. 32. From this will be extracted the various screens, such as 503, 505, and 507, for this search data and the appropriate part of the scroll bar highlighted. For example, 505 would correspond to FIG. 5. In this way, the method creates the illusion of being to scroll through a search data list, even though the DVD specification lacks this ability, by forming from the list a sequential (in terms of the list and the scroll bar) series of screen each displaying a contiguous portion of the whole list.

Concerning examples of self-referential data, this can be displayed in several different ways. For example, this can be displayed as a static screen as seen in FIG. 9, which includes the bit budget 491 as well as other self-referential data. The bit budget display 491 is similar to the sort of display presented by a PC to show how full a drive or disc is; however, in that case the PC determines this, while in the present invention, as a DVD player lacks the processing capability for this, this information is determined along with the search data and written onto the medium as part of the media image. Another example is the progress bar 471 of FIG. 7, which can be implemented using subtitle animation. In this case, the progress will just provide feedback, not allowing the user to move the point of play in the presentation data.

The second exemplary embodiment is based on a mobile player designed for the playback of a music disc that includes specific user interface elements that standardize interaction and title play. Whereas the first exemplary embodiment of FIGS. 1-10 allows for the display of an entire screen of metadata or search data, the second exemplary embodiment uses a specialized screen of a smaller size, as shown at 731 of FIG. 12. In addition to disc drive that will read the presentation data, metadata, and search data from the disc, the player will include the display 731 and the surrounding interface. The player will read text files of the non-presentation data generate the appropriate lists for display. Additionally, some of the buttons that formerly appeared on the screen have been moved to actual buttons on the interface.

The interface elements that standardize interaction include (FIG. 12):

Navigation buttons (701): An arrow panel with up, down, left and right surrounds an Enter button. The outer circumference of this object is a shuttle/jog wheel used to fast forward or reverse in a song.

Main button (703): This button provides an easy way to return to the main menu.

Mode button (705): This is used to toggle between Shuffle, Random and Repeat play.

Surround button (707): This is used to toggle between stereo and surround playback.

Language button (709): Changes the playback language of the display.

Record button (711): This anticipates a capability to record broadcast music in a recordable DVD player, adding to an individual's compilation.

Scrollbar (713): A scrollbar on the right-hand side of the display provides visual feedback about the current location in a list, or in a multi-part screen.

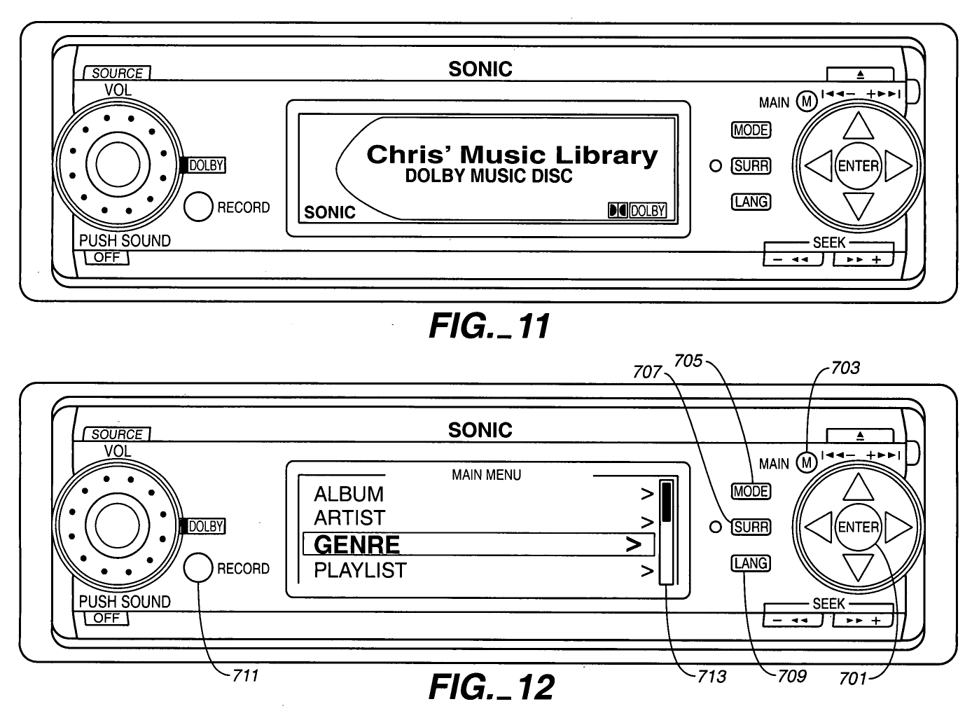

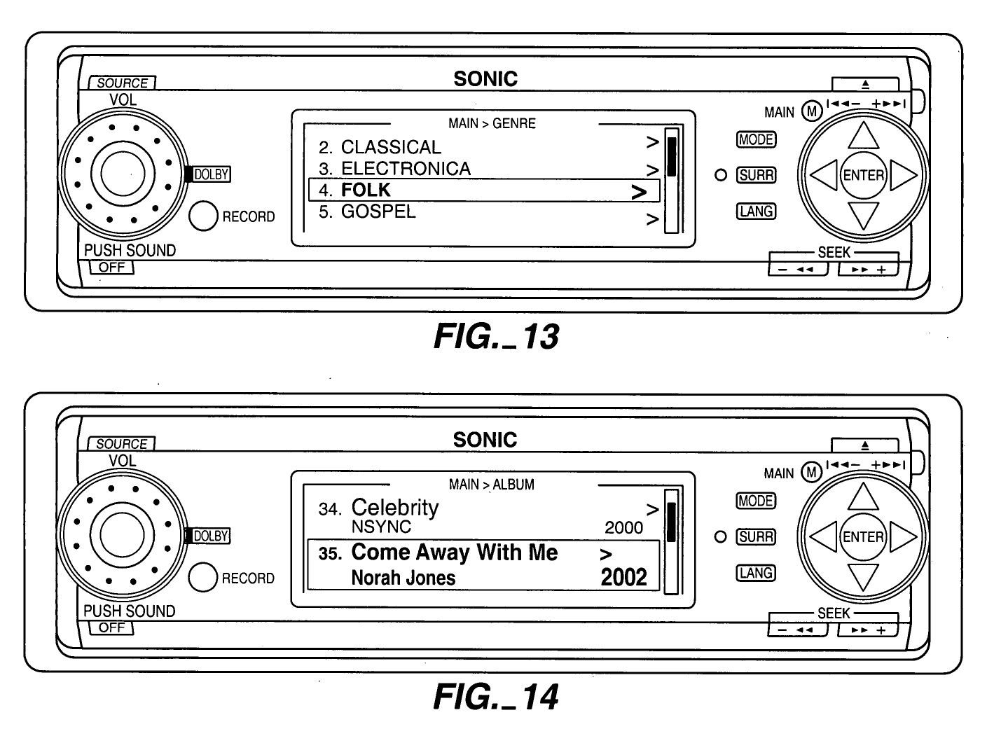

Playback of a disc begins with inserting it in the mobile player. A splash screen (FIG. 11) comes up and identifies the title. It goes away after, say, approximately five seconds, and is replaced by the main navigation window. The main navigation window (FIG. 12) allows the user to search the music disc by album, artist, genre, playlist or title. The list is scrolled using the up/down arrows, and a selection is made using either the Enter button or the right arrow. A selection is made using the arrows on the remote control and scrolling through the list, and then clicking Enter on the choice. They can also choose About. The listener chooses to search by genre, which they select and then Enter. The Genres screen (FIG. 13) is displayed, allowing them to pick one that meets their mood. Selections are made using the navigation pad. They make their selection, and a list of albums within this category appears. The album list (FIG. 14) contains additional information, including artist and year of release. The listener clicks on the album they want to listen to, and then the Album Details screen appears.

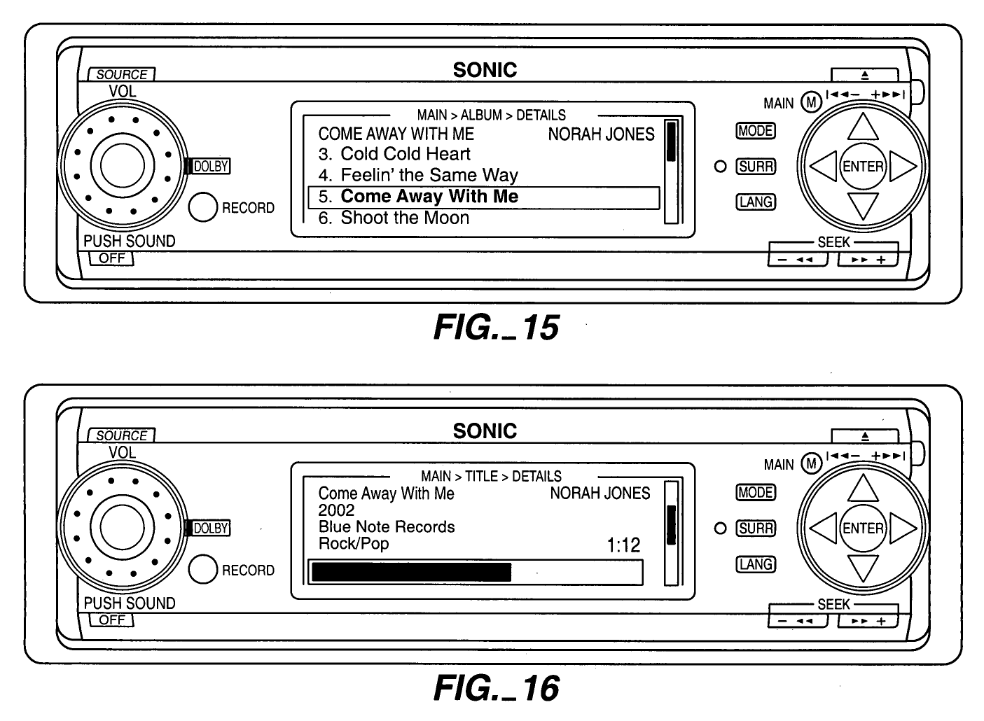

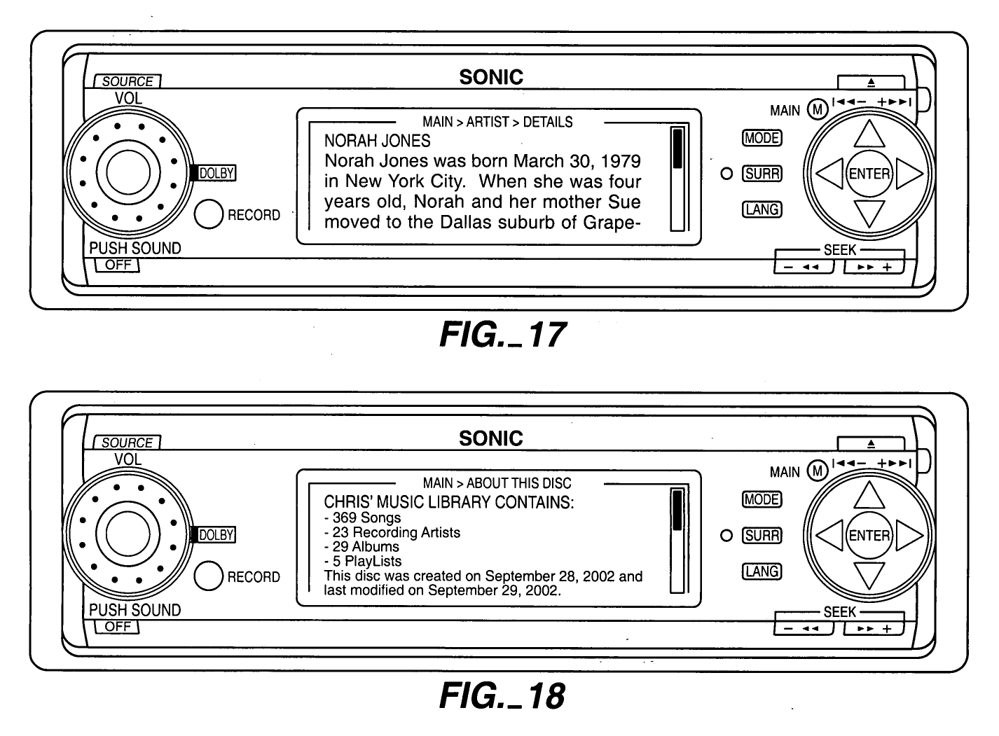

The Album Details screen (FIG. 15) includes the track list for the album. The listener can play all songs in the album—that is the first selection item in all cases—or scroll through the track list and play an individual track. While the track is playing, a Title Details screen (FIG. 16) is displayed, with information on that particular song. This screen includes a progress bar, and the screen is updated as each new track is played. The listener might want to find out more about the artist, so clicks on the artist's name in the Title Details screen, and they are presented with a biography (FIG. 17).

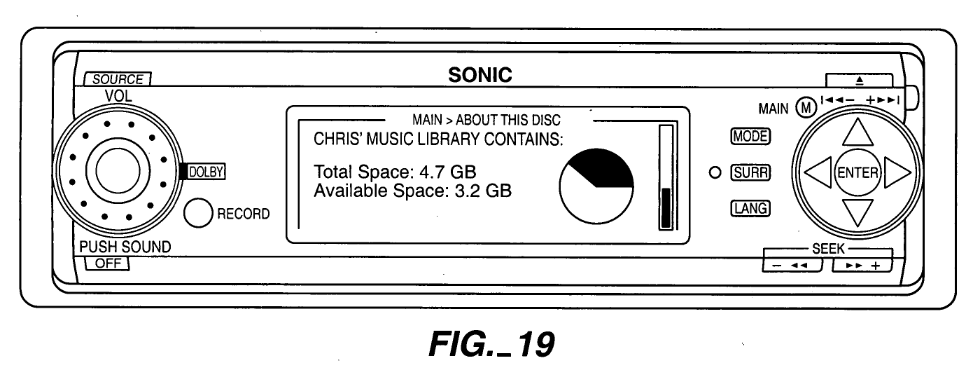

As tracks are added to the disc, the available space is used up, and it is helpful to get a snapshot of how much room is available to store new downloads. The Disc Info screen (FIGS. 18 and 19) provides an easy means of finding that out. It is a multi-part screen that can be scrolled using the arrow keys or the shuttle/jog wheel. FIGS. 18 and 19 are examples of different parts of the same DVD screen being split for display in the second embodiment.

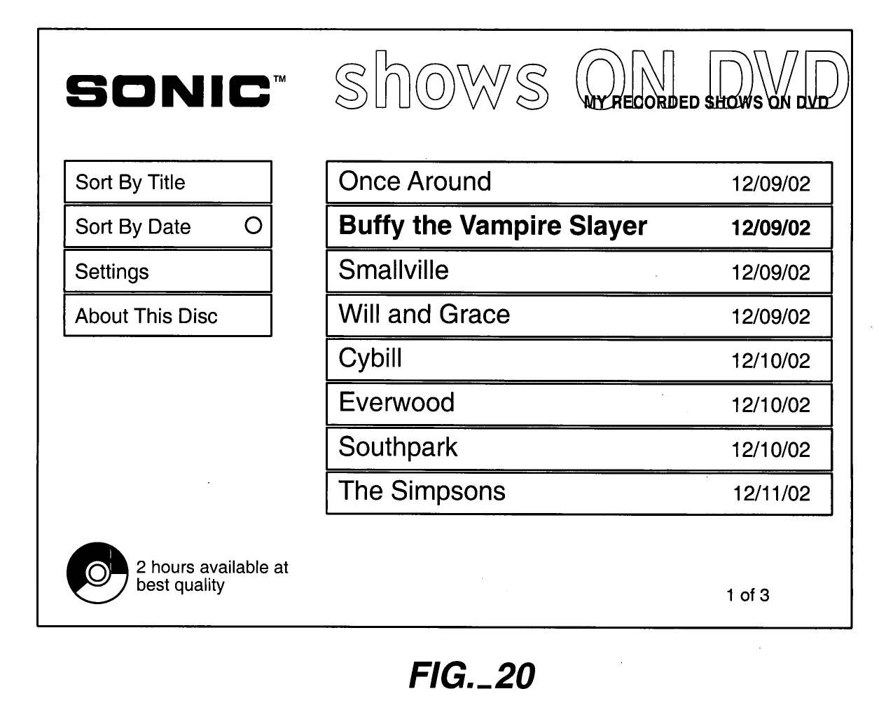

A third exemplary embodiment is a video embodiment and shown in FIGS. 20-23. This is similar in many respects to the first pair of embodiments, but the information and how it is displayed is changed somewhat due to the different nature of the material.

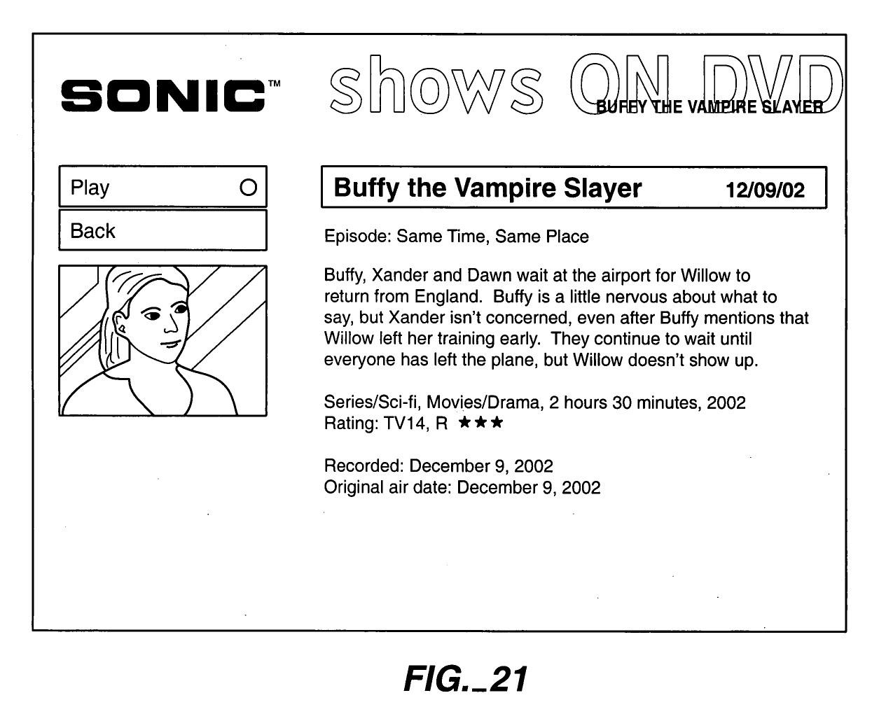

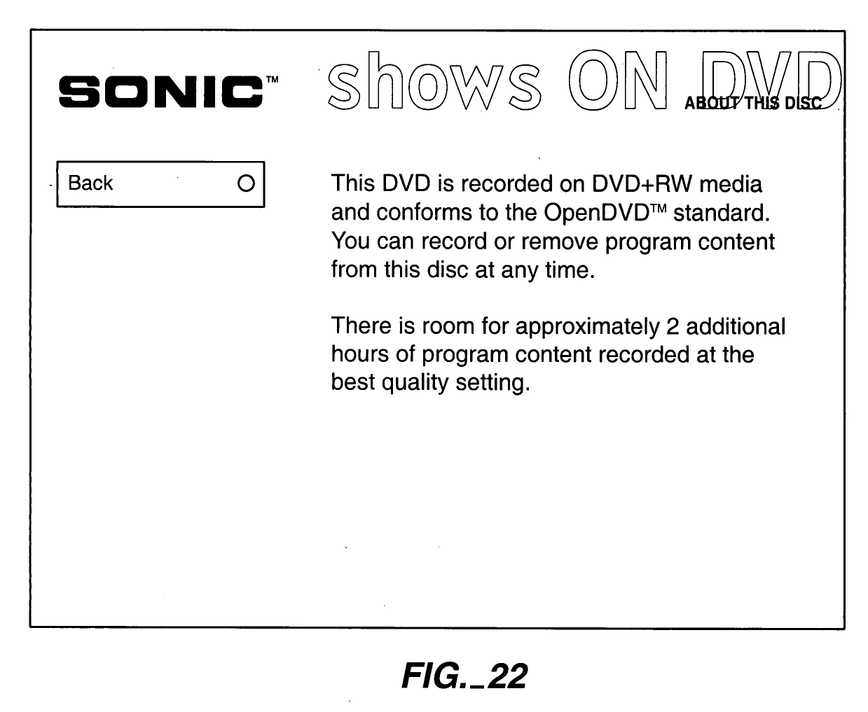

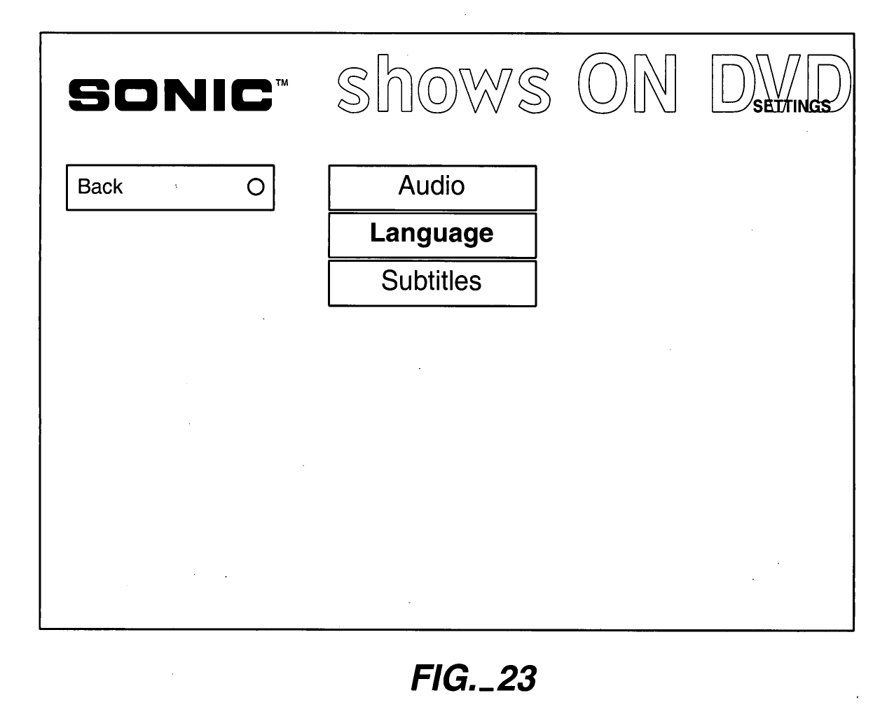

FIG. 20 shows a listing of recorded programs, buttons to other menus, and the space available on the disc (the bit budget) and is similar to FIG. 5 in function. FIG. 21 contains metadata on the program selected in FIG. 20. FIG. 22 is an example of an “About” screen, describing the particular disc's properties. FIG. 23 is a settings screen and is similar to that of FIG. 10, but for the video application. Similarly to the music embodiment, a PC can be fed a list of shows, which will then be captured, the metadata will be obtained from, say, Directshow, and the search data rendered to construct the various screens, resulting in the entire media image produced automatically for the selected titles.

The contents of an exemplary embodiment of the disc are now described in more detail in the context of a music disc, such as used in the first two embodiments described above. The disc is segmented into two primary areas: The OpenDVD “egg” portion, such as is described in U.S. patent application Ser. Nos. 10/123,816 and 10/408,027, and the area for standard DVD-Video content.

The egg contains all of the metadata that allows the project to be re-opened at a future time, and also all of the metadata which provides the unique, on-screen descriptive and navigation capabilities of the disc architecture. This includes:

DVD Project: Includes all of the Edit-on-DVD™ information for opening, re-editing, and changing content on the disc.

DVD Navigation: Reproduces all of the navigation so that mobile players can navigate, without the need for a graphics display.

Content Description: Descriptive metadata for the content

Disc

Title: The title of the disc, defined by the creator.

Creation date: The date at which the disc was first created, automatically entered by the authoring application.

Last modification date: The most recent modification date, automatically entered by the authoring application.

Serial number: A unique serial number that identifies the disc and the specific software which was used to create it, automatically created by the authoring application using a standard algorithm (across all products).

Creator: The creator's name, defined by the creator.

Comments: Free-form comments from the creator, intended to provide a more thorough description of the contents.

Album

Title: The album title (from AMG, for example, or other source).

Copyright date: The copyright date for the album (from AMG, for example).

Artist: The recording artist (from AMG, for example).

Label: The recording label (from AMG, for example).

Jacket picture: An image of the album cover (from AMG, for example).

Genre: The genre of the album.

Playlist: The song list of the album (from AMG, for example, correlated with the actual contents during download or ripping).

Artist

Name: The artist's name (from AMG, for example).

Biography: A biography of the artist (from AMG, for example).

Picture: An image of the artist (from AMG, for example).

Playlist

Title: A user-defined name which identifies a playlist.

Creation date: The date on which the playlist was first created (automatically provided by the authoring application).

Last modification date: The most recent date on which the playlist was modified (provided by the authoring application).

Playlist: The song list of the playlist (provided by the creator using the authoring application, the specific values for which are provided by AMG, for example).

Title

Name: The name of the song (from AMG, for example).

Copyright date: The copyright date for the song (from AMG, for example).

Duration: The song length (from download or ripping).

Genre

Genre list: A list of genre names, for genres on the disc.

This area can also contain information on digital rights.

The DVD-Video portion of a Dolby Music Disc is formatted to be fully compliant with the DVD Forum's specification for DVD-Video, allowing the disc to play on any existing DVD player. The content used within the context of the exemplary music disc includes the following:

Audio tracks: Standard, Dolby Digital™-encoded stereo audio, with the ability to expand to 5.1 Pro Surround.

Slideshows: Slides may optionally be included for playback during songs, as well as for an image of the recording artist.

Menus: Feature selection and the TOC-oriented database searching of contents by album, title, genre and artist are provided through DVD menus.

Jacket Picture: Each song includes album art.

Text Data: Each song includes descriptive text, for content identification when played on mobile DVD players.

eDVD™-Embedded links to Web-based content can be included in menu content.

As described above, the disc can also include a bit budget. The space allocation on a DVD is 4.7 GB (=4,700,000 bytes—within the DVD specification, a KB is not equivalent to 1,024 bytes, as might be expected). For the purposes of discussion, a music disc will be imagined to contain 1,000 songs (this determines how many jacket pictures would be required, for example), 100 albums, and 100 playlists. The space is allocated approximately as follows:

| Content | Space Allocation (MB) |
|---|---|
| OpenDVD | 20.3 |
| Jacket picture | 2.5 |
| Text data | 0.1 |
| Audio/slideshows | 4,699,977.1 |

These values are again rough estimates. For the Open DVD value, a standard egg for a project of this complexity is, say, around 20 MB in space. Additional overhead is provided for the metadata that accompanies the audio contents, allowing approximately 2 KB per album and 100 bytes per title, for a total of approximately 300 KB. When slideshows and pictures are saved at full-resolution with the egg, they can add considerably to the overhead, but within the context of a music application, this content can be saved as part of the MPEG stream. A full-size jacket picture image is approximately 1 MB uncompressed, and about 25 KB compressed. For 100 albums, this would require about, say, 2.5 MB. Text data is used to provide a description of the album, artist and track names for mobile players. Typically, this is expected to be no more than 64 characters per name. For 1,000 songs, 100 albums and 100 playlists, this yields a total of less than 100 KB.

The disc format allows for user-defined slideshows to be included, and the space used for slides takes away from the space available for music. A disc with only music on it, however, would have the full space available for audio, and at a 192 kbps encoding rate, this results in approximately 3,264 minutes of audio (or about 3.26 minutes per song).

There are many approaches to the structure and definition of how the disc might be designed. The following is an exemplary embodiment to illustrate the capabilities that can be included, again using the audio format of the first embodiment.

The Splash screen (FIG. 1) defines the disc when it is loaded. It can also be used to convey brand identity, in this example for Sonic and Dolby. It appears on the initial launch of the disc, and is displayed for about five to ten seconds, after which it automatically goes away and the primary navigation screen appears. The logos also appear on this screen in this example. Clicking on either of these logos launches a special web page at the company's site, and the URL includes specific serialization information that uniquely identifies the disc. The name of the disc, as defined by the DVD author, is the most prominent aspect of this screen. In general, it will be a text string of up to about 32 characters, large enough to easily be read on a TV set from about twelve feet away. There is background image, such as a motion menu, behind the buttons.

The Primary Navigation screen (FIG. 2) is really the entry point for the disc, and the main navigation location. It provides a means for the listener to determine how they want to search for content, and it appears immediately, and automatically, after the splash screen goes away. It is also the primary “return” location from most other screens. There is a title on this screen which is the name of the disc as defined by the author. It can also include logos, which can appear on all screens, in a manner similar to a TV watermark. They can also be eDVD links back to their respective websites. This menu provides the primary navigation, allowing the user to search by album, artist, genre, playlist or title. In addition, it provides access to settings, disc information and online help. The up/down/left/right arrows on the remote control are used to navigate this list. As a line is selected, it provides visual feedback. This is true for every screen beyond the splash screen.

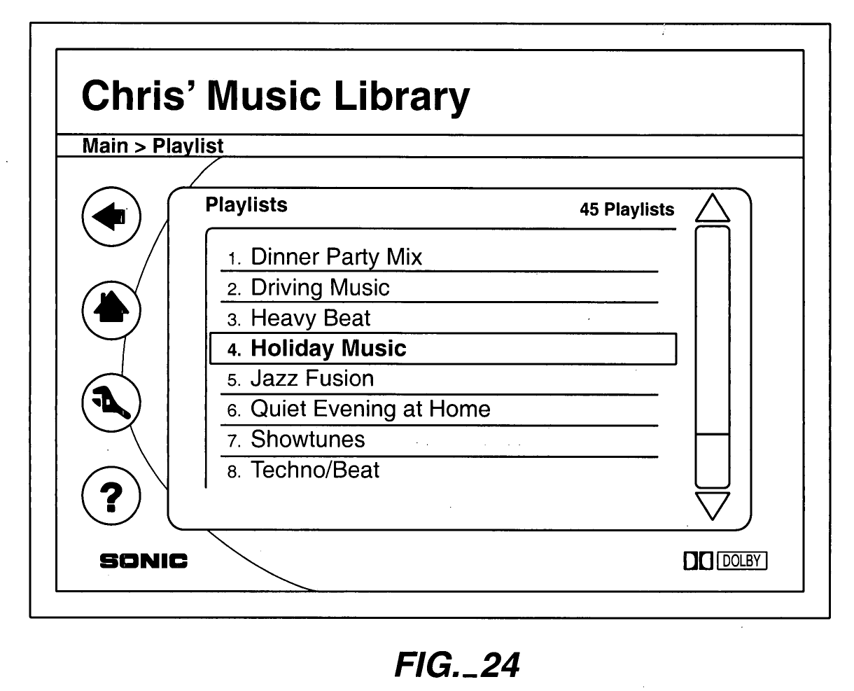

Playlists provide a convenient mechanism for the author to create their own mixes and albums of favorite content, and the Playlists screen (FIG. 24) is where a playlist is selected for playback. It is displayed when Search by Playlist has been selected in the Primary Navigation screen, and may span across multiple screens (with inter-screen navigation added as necessary). The screen includes a list of playlist names that are defined by the disc creator. The names are up to 32 characters in length and are sorted in alphabetic order. Clicking on a playlist name launches the Playlist Detail screen.

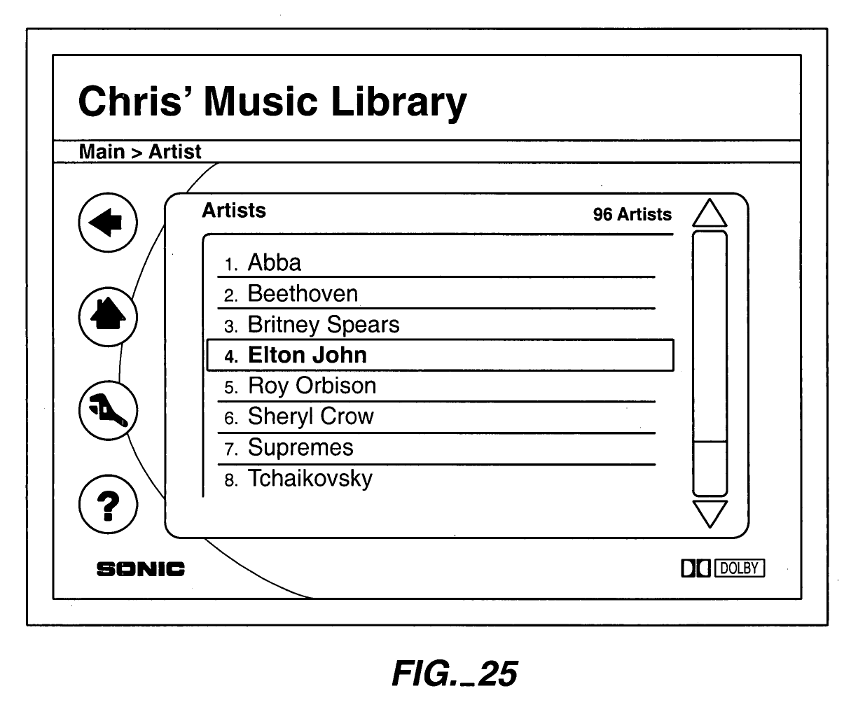

The Artists screen (FIG. 25) provides a convenient means of finding the music. produced by a specific recording artist. The screen consists of a list of artists, by name, in alphabetic order. Clicking on the Artist name brings up Albums with the albums created by that specific artist.

The Genres screen (FIG. 3) allows songs to be found for particular genre preferences and includes a list of genres in alphabetic order. Clicking on a genre brings up the Albums screen with the albums that fit within the chosen genre.

The Albums screen (FIG. 5) provides a list of albums, in alphabetic order, that fit within a particular search category, and is launched from one of multiple screens. Clicking on an album brings up the Album Details screen.

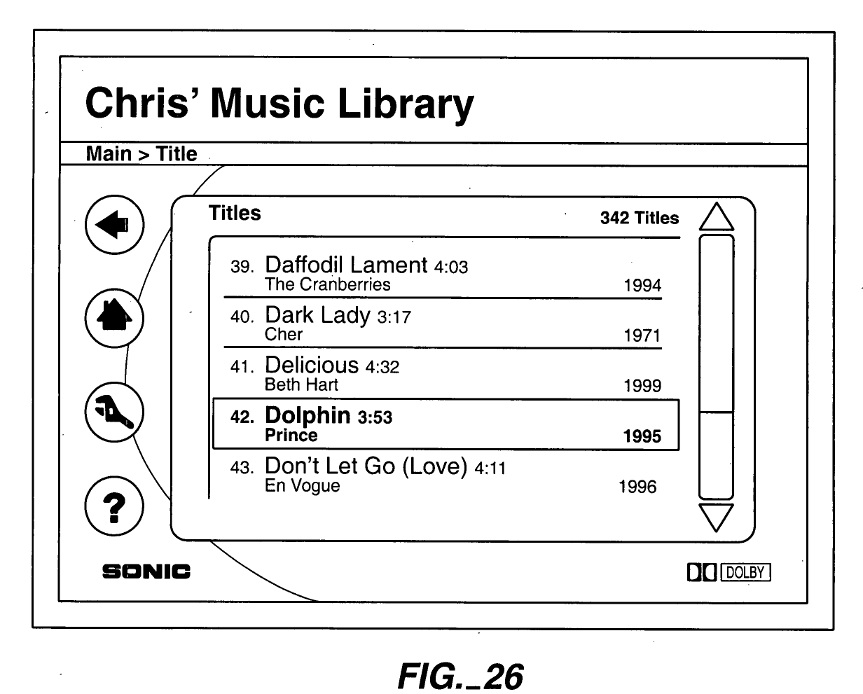

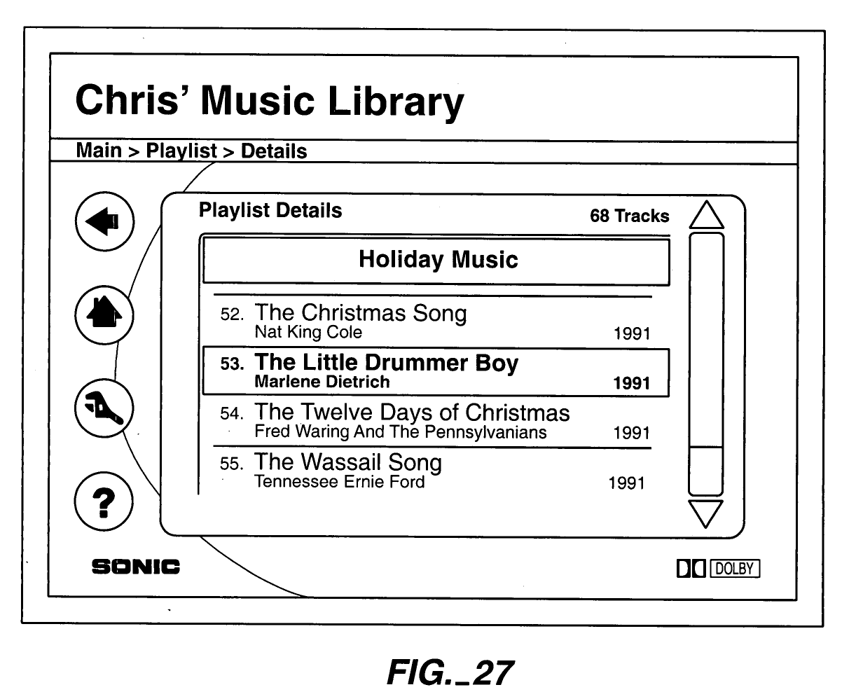

The Titles screen (FIG. 26) includes a list of song titles, in alphabetic order, which when clicked upon, brings up the Title Details screen. The Playlist Details screen (FIG. 27) lists all of the tracks that are included in a specific playlist. Clicking on a song title in the playlist results in the song being played. The first entry in this list is “Play all songs in this playlist”. FIG. 20 shows a Titles screen for the third embodiment.

The Album Details screen (FIG. 6) is similar to the Playlist Details screen (as albums are, after all, simply a special class of playlist). The title of the screen is the name of the album. It contains multiple line items—one for each track in the album that has been included on the disc—which can be clicked on to play. The first entry in this list is “Play all songs on the album”. This screen includes a list of details about the album, including the album name, its genre, the recording label under which it was published, an image of the album, and an image of the artist. The text for each song track line item includes the song track name and its duration. Clicking on the picture of the artist brings up the Artist Details screen. Clicking on a track plays it, while simultaneously displaying the Title Details sequence.

The Artist Details screen (FIG. 8) provides interesting information about the performing artist, including an image of the artist and a biography (if available). It is titled with the name of the recording artist.

The Title Details (FIG. 7) sequence consists of one or more slides which provide background information on the song track being played. The first screen is titled with the name of the song track, and includes the name of the title, the artist, the album name, the date, and an image of the album cover. It may remain up for the duration of the song, or there may be additional slides if available. If there are multiple slides, they are presented as a slideshow, with each slide being displayed for an equal portion of the time of the track play time. When there is a slideshow, the first slide is duplicated as the last slide, as well. FIG. 21 shows a Title Details screen for the third embodiment.

The Settings screen (FIG. 10) provides a means to adjust playback parameters for the disc. It includes a means of changing the playback state for shuffle, repeat and random play, pictures, the language, Dolby Digital stereo or surround audio, as well as links to the About and Legal screens. In a video oriented application, a screen such as FIG. 23 could be used.

The Help screen (FIG. 4) provides context-sensitive help based on which screen the user is viewing. The About screen (FIG. 9) provides descriptive information about the authoring of the disc, and is titled About this Dolby Music Disc. It includes a textual description of the author's name, the title of the disc, the date it was originally created, the date on which it was last modified, a Bit Budget pie chart and a description of the contents. FIG. 22 shows a Titles screen for the third embodiment.

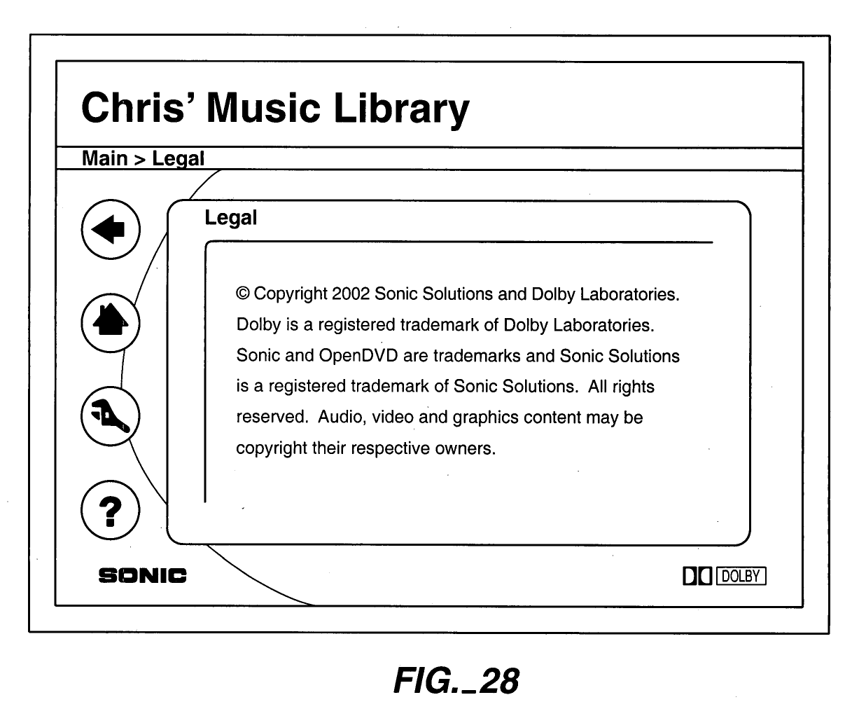

Legal text can be included on the disc to ensure that all intellectual property rights are protected. This screen (FIG. 28) communicates the legal statements, and is displayed when Legal has been clicked in the Settings screen. There is only a single line of navigation, which returns the listener to the Settings screen, and it is selected by default. Exemplary text is shown on the screen.

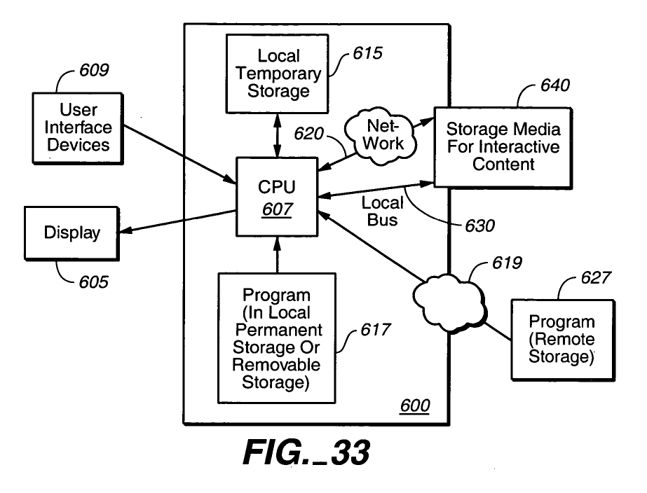

FIG. 33 shows an information appliance (or digital device) that may be understood as a logical apparatus that can read instructions from local storage 617 and/or remote storage 627 through a network connection 619. Apparatus 600 can thereafter use those instructions to direct server or client logic, as understood in the art, to embody aspects of the invention. One type of logical apparatus that may embody the invention is a computer system or consumer electronics devices 600 as illustrated in the block form in FIG. 33, containing elements such as CPU 607, input devices (such as a keyboard or mouse) 609, memory or disk drives 615, and display or speakers 605. Data storage media 615 and 617 may be used to program such a system and may represent a disc-type optical or magnetic media, magnetic tape, solid state memory, etc. The invention may be embodied in whole or in part as software recorded on this storage media. Communication port 619 may also be used to initially receive instructions that are used to program such a system and may represent any type of communication connection. Disc images, uncomposited assets, authoring project files, and other data are read from or written to storage media 640 by means of local bus 630 or remote data port 620 or other data input/output mechanisms. For example, presentation data could be from the internet though data port 620 or from a DVD/CD drive at 609, metadata could be requested and received over the internet though port 620, and user input received by a keyboard and mouse at 609.

The invention also may be embodied in whole or in part within the circuitry of an application specific integrated circuit (ASIC) or a programmable logic device (PLD). In such a case, the invention may be embodied in a computer understandable descriptor language which may be used to create an ASIC or PLD that operates as herein described.

Although the various aspects of the present invention have been described with respect to specific exemplary embodiments, it will be understood that the invention is entitled to protection within the full scope of the appended claims.

It is claimed:

1. A method of forming content for an interactive medium, comprising:
receiving first presentation data;
receiving first metadata associated with the first presentation data;
rendering first search data corresponding to the first metadata and forming the search data into menus from which portions of the presentation data can be selected; and
formatting the first presentation data, first metadata, and first search data as a media image.

2. The method of claim 1, further comprising:
writing the media image to the medium.

3. The method of claim 1, wherein the medium is a DVD based medium.

4. The method of claim 1, wherein the medium is a CD based medium.

5. The method of claim 1, wherein a portion of the search data formatted as menus includes a set of menus containing overlapping portions of a list of search data each having a plurality of buttons arranged into a scroll bar-type structure whereby a user can move between said individual ones of the set menus.

6. The method of claim 1, further comprising:
subsequent to receiving the first presentation data, requesting metadata associated with the first presentation data, the first metadata being provided in response.

7. The method of claim 6, wherein said requesting is performed automatically in response to receiving the first presentation data.

8. The method of claim 7, wherein said requesting is performed in response to a user input.

9. The method of claim 1, further comprising:
prior to rendering the search data, receiving one or more search criteria.

10. The method of claim 1, further comprising:
rendering self-referential data based on one or more of the presentation data, metadata and search data for the medium, and wherein said formatting further includes formatting the self-referential data within the media image.

11. The method of claim 10, wherein the self-referential data includes an indication of the amount of space used and remaining for use on the medium.

12. The method of claim 1, further comprising:
automatically generate multi-lingual content for portions of the first metadata and the first search data.

13. The method of claim 1, further comprising:
prior to said rendering first search data, receiving from the medium second metadata data associated with second presentation data on the medium, wherein first search data further corresponds to the second metadata.

14. The method of claim 1, wherein said rendering first search data corresponding to the first metadata comprises:
sorting the first metadata by a set of tags;
compiling a library of the sorted first metadata; and
wherein said formatting includes:
assembling the library into a collections of menus.

15. An electronic data file, on a storage medium, that when transferred into an appropriately configured digital apparatus causes the apparatus to operate in accordance with a process for forming an interactive media content, the process comprising:
receiving first presentation data;
receiving first metadata associated with the first presentation data;
rendering first search data corresponding to the first metadata and forming the search data into menus from which portions of the presentation data can be selected; and
formatting the first presentation data, first metadata, and first search data as a media image.

16. The method of claim 15, wherein the interactive medium is a DVD based medium.

17. The method of claim 15, wherein the interactive medium is a CD based medium.

18. The method of claim 15, wherein a portion of the search data formatted as menus includes a set of menus containing overlapping portions of a list of search data each having a plurality of buttons arranged into a scroll bar-type structure whereby a user can move between said individual ones of the set menus.

19. The method of claim 15, further comprising:
subsequent to receiving the first presentation data, requesting metadata associated with the first presentation data, the first metadata being provided in response, wherein said requesting is performed automatically in response to receiving the first presentation data.

20. The method of claim 15, further comprising: prior to rendering the search data, receiving one or more search criteria.

21. The method of claim 15, further comprising:
rendering self-referential data based on one or more of the presentation data, metadata and search data for the interactive medium, and wherein said formatting further includes formatting the self-referential data within the media image.

22. The method of claim 21, wherein the self-referential data includes an indication of the amount of space used and remaining for use on the interactive medium.

23. The method of claim 15, further comprising:
automatically generate multi-lingual content for portions of the first metadata and the first search data.

24. An interactive medium, the content of which includes a media image comprising:
presentation data;
metadata associated with the presentation data; and
search data corresponding to the first meta-data, whereby the search data is formed into menus from which portions of the presentation data can be selected.

25. The interactive medium of claim 24, wherein said presentation data is audio data.

26. The interactive medium of claim 24, wherein said presentation data is video data.

27. The interactive medium of claim 24, wherein said content further includes:
self-referential data about said interactive medium.

28. The interactive medium of claim 27, wherein the self-referential data includes an indication of the amount of space used and remaining for use on the interactive medium.

29. The interactive medium of claim 24, wherein said menus contain a scroll bar-type structure composed of a plurality of buttons whereby a user can move between individual ones of a set menus containing overlapping portions of a list of search data.

30. The interactive medium of claim 24, wherein said interactive medium is a DVD and the media image a disc image.

31. The DVD of claim 30, wherein said disc image conforms to the DVD-RW format.

32. The DVD of claim 30, wherein said disc image conforms to the DVD+R format.

33. The DVD of claim 30, wherein said disc image conforms to the DVD+RW format.

34. The DVD of claim 30, wherein said disc image conforms to the DVD-RAM format.

35. The DVD of claim 30, wherein said disc image conforms to the DVD-R format.

36. The interactive medium of claim 24, wherein said interactive medium is a CD and the media image a disc image.

37. The CD of claim 36, wherein said disc image conforms to the CD-R format.

38. The CD of claim 36, wherein said disc image conforms to the CD-RW format.

39. A system comprising:
a medium containing presentation data, metadata associated with the presentation data, and search data corresponding to the content of the metadata; and
a player whereby the metadata and the search data can be displayed and whereby presentation data can be chosen from a selection made from the search data.

40. The system of claim 39, wherein the medium is a DVD and the player conforms to the DVD standard.

41. The system of claim 39, wherein the presentation data is audio content.

42. The system of claim 39, wherein the presentation data is video content.

43. The system of claim 39, wherein the search data is a collection of menus.
